(19) United States
(12) Patent Application Publication
(10) Pub. No.: US 2005/0275943 A1
(43) Pub. Date: Dec. 15, 2005

(54) Polarizing plate and eyewear plastic article containing the same

(76) Inventors: Hideyo Sugimura, North Oaks, MN (US); Xuzhi Qin, Hacienda Heights, CA (US)

Correspondence Address: INSKEEP INTELLECTUAL PROPERTY GROUP, INC, 2281 W. 190TH STREET, SUITE 200, TORRANCE, CA, 90504, US

(21) Appl. No.: 11/199,006

(22) Filed: Aug. 8, 2005

Related U.S. Application Data
(63) Continuation of application No. 10/745,049, filed on Dec. 22, 2003, now abandoned.
(60) Provisional application No. 60/435,403, filed on Dec. 20, 2002.

(51) Int. Cl. G02F 1/1335; G02B 5/30; G02B 27/28

(52) U.S. Cl. 359/490; 359/483

(57) ABSTRACT

A polarizing plate is formed with a non-polyvinyl alcohol based polarizing film, a thermoplastic support layer bonded to one surface of the polarizing thin layer, and a thermoplastic protective layer bonded to the other surface of the polarizing thin layer. The thermoplastic support layer is constructed from the same or similar material as the eyewear plastic article base. The thermoplastic protective layer is constructed from a resin sheet that is non-birefringent or highly birefringent. The polarizing plate can be advantageously used in eyewear articles such as sunglasses and goggles for glare reduction. The polarizing plate can be more advantageously used for the production of eyewear optical articles through an insert injection molding technique due to its high heat stability and moisture resistance.

### CROSS REFERENCE TO RELATED APPLICATIONS

This application claims the benefit of priority from U.S. Provisional Application Ser. No. 60/435,403 filed on Dec. 20, 2002. This application also incorporates by reference the following commonly assigned co-pending application U.S. Ser. No. 10/684,202 filed Oct. 10, 2003, entitled Polarizing Plate and Plastic Optical Article.

### BACKGROUND OF THE INVENTION

1. Field of the Invention

This invention relates to a polarizing plate comprising a thermoplastic support layer, a polarizing thin layer (film), and a non-birefringent or highly birefringent thermoplastic protective layer. The polarizing plate has excellent polarization efficiency, heat stability, and moisture resistance, and does not form a colored interference fringe to white light when viewed with the protective layer facing the polarizing source. The excellent heat stability and moisture resistance are archived by using a non-polyvinyl alcohol based polarizing film. The polarizing plate of this invention can be advantageously used in eyewear optical articles such as sunglasses and goggles for glare reduction. The polarizing plate of this invention can be more advantageously used for the production of eyewear optical articles through an insert injection molding technique.

2. Description of the Related Art

It is well known that polarizing films or plates are used in sunglasses and goggles to eliminate glare reflected from surfaces such as water and road. Polyvinyl alcohol (PVA) based polarizing film (hereon interchangeable with the term of polarizing thin layer) with either iodine or hydrophilic dichroic dyes as polarizing elements are most widely used. Due to the high sensitivity of PVA material to moisture and heat, a PVA polarizing film is usually made into a polarizing plate in which the polarizing film is protected by two surface protective layers made of the same thermoplastic material. Various thermoplastics are used as protective layers to prolong the life of the polarizing thin layer while keeping the optical properties of the polarizing film.

U.S. Pat. No. 4,387,133 disclosed a laminated light polarizing sheet with a conductive coating (film) on one surface. It has a supporting film having retardation less than 30 nm, and selected from cross-linked phenoxyether, polysulfone, and polyacrylonitrile.

U.S. Pat. No. 4,427,741 disclosed a polarizing film comprising a polarizer and a heat-treated film formed on at least one surface of the polarizer. It is required for the heat-treated film to have a retardation value of about 500 nm or less. The film is made of a thermoplastic selected from polycarbonates, polysulfones, polyethersulfones, polyesters, polyamides, and poly(estercarbonate)s'.

U.S. Pat. No. 4,592,623 described a polarizing plate having a polyester protective layer bonded to at least one surface of the polarizing film. According to the inventors, colored interference fringes are not formed in this polarizing plate, if the following two conditions in the protective film are satisfied: 1) the minimum or maximum refractive index in a direction in parallel with the plane of the film is nearly equal to that in the direction of the film thickness, and b) the retardation is at least 10,000 nm.

U.S. Pat. No. 4,774,141 used polysulfone type films such as polysulfone, polyether sulfone, polyarylsulfone and the like, as protective layers for a PVA polarizing film.

U.S. Pat. No. 5,051,309 disclosed an anti-dazzling polycarbonate polarizing plate comprising a PVA polarizing layer and a polycarbonate sheet having a retardation value of at least 2,000 nm bonded to one or both surfaces of the polarizing layer. It is claimed that no colored interference fringes are observable in polarizing plates constructed from such oriented polycarbonate sheets.

More recently, U.S. Pat. Nos. 5,914,073, 6,055,096, and 6,068,794 disclosed a series of functional protective films for polarizing plates, including hard coating, UV blocking, and anti-static functions.

The prior art teaches the use of thermoplastic materials as the protective layers to prolong the life of a PVA based polarizing film and to provide additional functions to a polarizing film, and methods to avoid colored interference fringe in the protective layers under polarized light. The prior art does not appear to teach, however, a polarizing plate that realizes regular non-heat treated, non-oriented sheet of polycarbonate solely as a support layer, which faces the viewer after incorporation in an eyewear optical article such as a lens of sunglasses. The support layer may have significant birefringence characteristics and exhibit colored interference fringe under polarizing light. However, these deficiencies should not affect the use of the polarizing plate in optical articles such as sunglasses, goggles, or sun visors.

Additionally, in the application of polarizing film or plate in eyewear optical articles, much attention has been directed to incorporation methods such as the insert injection molding method disclosed in U.S. Pat. No. 6,328,446. Polarizing films based on iodine absorbed PVA film is very susceptible to color change under the high temperature processing condition in an injection molding process. Discoloration and loss of polarization efficiency usually happen even when laminated between protective layers. Polarizing films based on hydrophilic dichroic dye absorbed PVA film, providing better heat and moisture resistance, remain to be the primary type of polarizing film used in the high temperature process of manufacturing polarized eyewear optical articles.

Alternative polarizing plates not based on solely dichroic dye absorbed PVA film are sought for much improved heat stability and moisture resistance while having comparable optical properties and similar or less cost.

### BRIEF SUMMARY OF THE INVENTION

It is thus a first object of the present invention to provide a polarizing plate that uses a polarizing film having better moisture and heat resistance than PVA based polarizing film.

It is a second object of the present invention to provide a polarizing plate that uses a thermoplastic resin sheet as the protective layer and a thermoplastic resin sheet as the support layer. In this regard, it is not required for the support layer to be oriented or specially treated by other means. Such a polarizing plate should be advantageously low cost, while having excellent impact strength, moisture and heat resistance.

It is a third object of the present invention to make a thermoplastic sheet layer supported polarizing plate that can be conveniently incorporated into a plastic optical article, e.g. a polarized lens, using an insert injection molding method. The thermoplastic support layer is thermally integrated (fused) into the base of the plastic optical article.

It is a fourth object of the present invention to provide a polarizing plate that does not show colored interference fringes when observing the plate with the protective layer facing to the polarized light.

A first object of the present invention is achieved by using non-polyvinyl alcohol (PVA) base polarizing film. That is, the material of the base polymer film of the polarizing film is not PVA. Usable non-PVA polarizing films include those based copolymer of PVA and polyvinylene, those based on polyethylene tetraphthalate (PET) or polyethylene naphthalene (PEN), those based on liquid crystal polymers (LCP), and those based on solely dichroic dye crystals (thin crystal film, TCF).

A second and the third object of the present invention are achieved by constructing a multi-layer laminated polarizing plate comprising a support layer, a polarizing film layer, and a protective layer. The support layer is constructed from a thermoplastic resin and has similar or the same composition as the optical plastic base that the polarizing plate will be incorporated on. The support layer does not need special treatment such as stretching to introduce orientation or annealing to remove birefringence. When the polarizing plate is incorporated into a plastic optical article using an insert injection molding method, the optical plastic base material is always molded onto the support layer of the polarizing plate.

Various additives may exist in the laminated plate. There may optionally exist another layer between the support layer and the polarizing film to provide better handling or adhesion if needed.

It is not necessary, although preferred, to have the same material and same optical property for both the protective and the support layers.

A fourth object of the present invention is archived by using a protective layer that is either non-birefringent or highly birefringent. By the term “non-birefringent”, it is meant that the retardation value as defined later is less than 200 nm and the stress-optic coefficient of the thermoplastic material is less than 30×10⁻⁶ mm²/N. Non-birefringent thermoplastic materials include optically isotropic materials. By the term “highly birefringent”, it is meant that the retardation value is higher than 2,000 nm.

Suitable thermoplastics materials include esters of cellulose, polyesters, polycarbonates, blends of polyester and polycarbonate, polysulfones, polyarylates, polyacrylates, polyamides, polystryene, etc.

The polarizing plate of the present invention can be advantageously used to provide anti-dazzling performance to an optical part such as a sunglass lens, a goggle, a sun visor, or a helmet. It is especially advantageous to use the polarizing plate of the present invention in polycarbonate based optical parts.

When the support layer of the polarizing plate of the present invention is a polycarbonate sheet, it is primarily used in manufacturing polycarbonate polarized lenses using the insert injection molding method. By changing the support layer to different materials, the embodiments of the present invention also apply to other thermoplastic materials that have not yet been adapted to the ophthalmic lens industry.

The terms “polyvinylene” and “polyacetylene” is used interchangeably.

### DETAILED DESCRIPTION OF THE INVENTION

The polarizing plate in the present invention comprises three main layers: a thermoplastic protective layer, a polarizing thin layer, and a thermoplastic support layer. The polarizing thin layer (film), which is a main component of the polarizing plate of the invention, is a film transmitting only a light having a wave front of a specific direction. Currently, there are at least four types of polarizing films that can be used to realize the polarizing films that have improved heat and moisture resistance in accordance with the present invention:

(a) a polarizing film based on copolymer of PVA and polyvinylene or blend of PVA and polyacetylene, in which the polarizing elements are the polyvinylene units;

(b) a polarizing film based a hydrophobic polymer (e.g., PET) doped with water insoluble dichroic dyes, in which the polarizing elements are the dichroic dyes;

(c) a polarizing film based on a liquid crystalline polymer doped with dichroic dyes, in which the polarizing elements are the dichroic dyes;

(d) a polarizing film based on a thin film of dichroic dye crystals, in which the polarizing elements are the dichroic dyes.

A usable PVA—polyvinylene copolymer polarizing film is disclosed in U.S. Pat. No. 5,666,223 as a K-sheet type polarizer. It is incorporated herein by reference. The K-sheet is a light polarizer sheet comprising a molecularly oriented sheet of polyvinyl alcohol—polyvinylene block copolymer material having the polyvinylene blocks thereof formed by molecular dehydration of a sheet of polyvinyl alcohol. The molecularly oriented sheet of polyvinyl alcohol—polyvinylene block copolymer material comprises a uniform distribution of light-polarizing molecules of polyvinyl alcohol—polyvinylene block copolymer material varying in the length (n) of the conjugated repeating vinylene unit of the polyvinylene block of the copolymer throughout the range of from 2 to 24. The sheet is stretched prior to, subsequent to, or during the dehydration step with the result that the light-polarizing molecules become oriented, and such that the degree of orientation of said molecules increases throughout said range with increasing length (n) of said polyvinylene blocks. Further, the concentration of each of the polyvinylene blocks remains comparatively constant (i.e., “balanced”) through 200 nm to 700 nm, thus providing balanced polarization. Polarizing films made from PVA—polyvinylene copolymers have high polarizing efficiency (>99%).

High efficient polarizing films can also be obtained from the blend of PVA and polyacetylene as disclosed in U.S. Pat. No. 5,073,014, which is incorporated herein by reference. To prepare such a polarizing film, polymerization of acetylene is conducted in the solution of PVA in a polar solvent under the effect of a nickel catalyst. The resulted blend of PVA and polyacetylene is cast into film and subsequently stretched by a ratio of more than 3.

In case it is desired that a PVA—polyvinylene (or polyacetylene) polarizing film provide a particular color or darkness to eyewear optical articles, color correction/darkening dyes may be added into the laminate plate. The dyes may exist in any of the layers including adhesive layers or an extra thermoplastic layer.

A hydrophobic polymer based polarizing film can be obtained, in general, blending a hydrophobic resin with a hydrophobic dichroic dye, then form a film by molten casting or extrusion, followed by uniaxially stretching the film to orient the dye. Preferred hydrophobic polymers include halogenated vinyl polymer resins, acrylic resins, polyolefin resins, polyamide resins, polyimide resins, polyester resins, polycarbonate resins, polyethersulfone resins and the like. More preferred are resins which contain at least 80 percent by weight of aromatic polyester resin components (such as polyethylene terephthalate, polyethylene naphthalate, polybutylene terephthalate and the like), polyimide resins, polyethersulfone resins, and polycarbonate resins which have excellent thermal resistance, moisture resistance, transparency, and stable birefringence after orientation.

In order to obtain a hydrophobic polymer based polarizing film that has a desired color and particularly a neutral gray color, it is preferable to blend a number of hydrophobic dichroic dyes into the base polymer. Furthermore, non-dichroic dyes may be used to correct the color if necessary.

A polarizing film based on PET and hydrophobic dichroic dyes is disclosed in U.S. Pat. No. 5,354,513, which is incorporated herein by reference. A hydrophobic polymer based polarizing film can be made by melting the base polymer together with dichroic dyes of choice, and other colorants added as desired, forming the colored molten polymer into a film or sheet, stretching it longitudinally or transversely at a temperature close to its glass transition temperature with a stretch ratio of 3 to 10, and then heat-treating it at a temperature of 100 to 250° C. for a period of time ranging from 1 second to 30 minutes. Although the just described unidirectional stretching may be adequate, the mechanical strength of the film can further be enhanced, if desired, by stretching it with a stretch ratio of about 1.1 to 2 in the direction perpendicular to the principal stretching direction.

A liquid crystalline polymer (LCP) based polarizing film can be made similarly as a hydrophobic polymer based polarizing film by replacing the base polymer to the LCP, except that no stretch is needed. The LCP may be a polyester, a polyamide, a polycarbonate, a poly(ester-carbonate), polyaramide, poly(ester-amide), and the like. Example LCP suitable for polarizing film can be found in U.S. Pat. Nos. 5,738,803 and 5,746,949. Their disclosures are incorporated by reference as if fully set forth herein.

Organic dichroic dyes commonly used to impart polarizing property to a hydrophobic polymeric film or a LCP film include vat dyes and organic pigments, quinonic dyes, pyrelene dyes, diazo dyes. There are a variety of patents that describe useful hydrophobic organic dichroic dyes. The following U.S. patents are enclosed and their disclosures are incorporated by reference as if fully set forth herein: 4,803,014, 4,824,882, 4,895,677, 4,921,949, 5,059,356, 5,286,418, 5,354,513.

TCF Polarizing films made from dichroic dyes applied on the surface of rigid or flexible substrate to form a layer of dye crystalline grid, is disclosed in U.S. Pat. No. 6,563,640, which is incorporated herein by reference. The polarizing ability of such film is achieved by mechanically orientating the dichroic dye that is coated on the substrate surface from a solution and subsequent drying under the conditions causing ordered crystallization of the dichroic dye. Suitable substrates for incorporating a TCF polarizing film into plastic optical article include polycarbonates and polyesters.

In addition to dye/colorant additives in polarizing film as aforementioned, they may also exist in the protective layer, the support layer, a separate thermoplastic layer, or adhesive layer. It is preferred to have the colorant(s) in the support layer. If the colorant(s) needs to be in a separate thermoplastic layer, it is preferred to have the separate thermoplastic layer between the polarizing film and the support layer.

According to the present invention, polarizing plates having excellent optical quality can be achieved with two types of thermoplastic protective layers. The first type of thermoplastic protective layer involves a thermoplastic sheet that is non-birefringent. It is either optically isotropic or has retardation value of below 200 nm and shows minimal birefringence under stress (i.e., the stress optical coefficient<30×10⁻⁶ mm²/N). The second type of thermoplastic protective layer involves a thermoplastic sheet that is oriented by unidirectional stretching to give a retardation value of greater than 2,000 nm.

With respect to non-birefringent thermoplastic protective layer, the typical thermoplastic resin example includes a cellulose ester, a norbornene resin (polycycloolefin), a copolymer of cyclic olefin, a syndiotactic polystyrene, and a polyacrylate. Of these, cellulose esters, polyacrylates, and copolymers of cyclic olefin are preferred in view of optical isotropic property and minimum introduction of birefringence during forming the polarizing plate into desired shape. Cellulose acetate butyrate are preferred in view of forming and molding compatibility with thermoplastic support layer resin such as polycarbonate.

Polycarbonate, having a stress-optic coefficient as high as 70×10⁻⁶ mm²/N, is not suitable for the protective layer although it is possible to have a polycarbonate film that has a very low birefringence and retardation value. For example, the stress introduced by the injection molding process or a thermo-forming process will impart marked interference fringes in the film.

There are many types of cellulose ester resins that can be used to make the cellulose ester protective film. Examples are those esters of low fatty acids such as cellulose acetate butyrate (CAB), cellulose acetate, cellulose biacetate, and cellulose triacetate (CTA). It is preferred for the cellulose ester of choice to have a phthalic ester type plasticizer. The loading of the plasticizer can be between 10% to 20%, by weight. Commercial available cellulose ester film products include Kodacel® of Eastman Kodak Co., Fuji Tack Clear of Fuji Photo Film Co., Konicatac of Konica, and OptiGrafix from Grafix Plastics (Cleveland, Ohio).

The resin for preparing the cyclic olefin copolymer (CoC) resin sheet preferably used in the invention is a polymer comprising a cyclic olefin monomer unit such as norbornene. The typical examples of the CoC resin are Zeonor® by Zeon Chemicals, Topas® by Ticona, Arton® by JSR, and APEL by Mitsui Chemicals.

The resin for preparing the polyacrylate resin sheet preferably is a polymer from C1 to C6 alkyl ester of (meth)acrylic acid, or a polymer from an aromatic ester of (meth)acrylic acid.

The polarizing plate of the present invention is intended for use in an optical part with the protective layer facing the light source. In order to eliminate or greatly reduce the colored interference fringe, the non-birefringent thermoplastic sheet used for the protective layer preferably has a small retardation value. The polarizing plate according to the invention, which comprises a protective film having a retardation of 200 nm or less in case of a cellulose resin, can give a satisfying result, although a retardation of 50 nm or less is preferable, 25 nm or less is more preferable for other resins, and can provide a polarizing plate with high performance.

The manufacturing method of the protective film having a low retardation value used in this invention is not limited. A conventional method such as a melt-extrusion method or a melt casting method, a solution casting method (band or drum) or a calendering method may be used. In the invention, the solvent casting film is preferably used in view of excellent surface property, isotropy or a reduced anisotropy.

With respect to the second type of thermoplastic protective layer having retardation value of at least 2,000 nm, thermoplastic resins having stable birefringence after orientation is preferred. The typical thermoplastic resin example includes an aromatic polyester (homopolymer, copolymer, or blending), a polycarbonate, a polyacrylate, a polysulfone, a polyarylate, or a blend of thermoplastic resins such as a polyester and a polycarbonate. Of these, polycarbonates, aromatic polyesters such as polyethylene naphthalate and blending of a polycarbonate with a polyester of high glass transition temperature are preferred.

There are various resins for manufacturing the polycarbonate sheet, and an aromatic polycarbonate is preferable, and a bisphenol A polycarbonate is especially preferable. Such a polycarbonate is obtained employing 4,4′-dihydroxydiphenyl alkane or a halogenated compound thereof according to a phosgene method or an ester exchange reaction method. The 4,4′-dihydroxydiphenyl alkane includes 4,4′-dihydroxydiphenyl methane or 4,4′-dihydroxydiphenyl ethane or 4,4,′-dihydroxydiphenyl butane.

The resin for preparing the polysulfone resin sheet preferably used in the invention includes polysulfone, polyether sulfone and polyarylsulfone, and the typical example thereof is poly(oxy-1,4-phenylene-1,4-phenylene) or poly (oxy-1,4-phenyleneisopropylidene-1,4-phenyleneoxy-1,4-phenylenesulfony I-1,4-phenylene).

The example polyester resins include polyethylene teraphthalate (PET), polyethylene naphthalate (PEN), polyarylate, and their copolyesters. Suitable copolyesters are based naphthalene dicarboxylic acid or its ester such as dimethyl naphthalate ranging from 20 mole percent to 80 mole percent and isophthalic or terephthalic acid or their esters such as dimethyl terephthalate ranging from 20 mole percent to 80 mole percent reacted with ethylene glycol. Others are based on isophthalic, azelaic, adipic, sebacic, dibenzoic, terephthalic, 2,7-naphthalene dicarboxylic, 2,6-naphthalene dicarboxylic or cyclohexanedicarboxylic acids. Other suitable variations in the copolyester include the use of ethylene glycol, propane diol, butane diol, neopentyl glycol, polyethylene glycol, tetramethylene glycol, diethylene glycol, cyclohexanedimethanol, 4-hydroxy diphenol, propane diol, bisphenol A, and 1,8-dihydroxy biphenyl, or 1,3-bis(2-hydroxyethoxy)benzene as the diol reactant.

In addition, blendings of polyesters (e.g., PET or PEN) with a polycarbonate can be used as the thermoplastic resin of the protective layer.

In the present invention, the retardation value, R, is defined by the following equation:
R=Δn·d

Wherein Δn is the birefringence of the thermoplastic protective layer, and d is the thickness (nm) of the layer.

By using a birefringent thermoplastic sheet as a protective layer, a polarizing laminate plate can be obtained lack of interference fringe colors even after the plate is formed into a spherical curved wafer or molded into an optical article such as a lens. The retardation value (R) of the thermoplastic sheet used in this invention as the protective layer is at least 2,000 nm, preferably at least 3,000 nm, especially preferably at least 5,000 nm. There is no particular upper limit, and generally, the upper limit is not more than 20,000 nm. If a thermoplastic sheet having an R value of less than 2,000 nm is used, a colored interference fringe tends to occur in the polarizing plate.

In constructing the polarizing laminate plate, it is preferred to achieve substantially parallel or perpendicular alignment between the absorption axis of the polarizing thin layer and a principle index of refraction of the birefringent protective layer. Such an alignment reduces polarization efficiency losses.

A thermoplastic sheet having the above retardation value for the protective layer can be produced by forming a sheet from an aforementioned thermoplastic resin by an ordinary extrusion method or casting method, and stretching the sheet substantially in one direction while heating it at a temperature slightly higher than its glass transition temperature. The thickness of the sheet and its stretch ratio affect the retardation value (R).

The thermoplastic sheet used in this invention for the protective layer may have its surface coated with a hard coating, or treated to improve an anti-haze property. The protective sheet used in this invention may contain necessary additives such as plasticizer, UV absorber, light stabilizer, heat stabilizer, etc.

Suitable thickness for the protective layer in this invention is between 0.02 mm to 1.3 mm, and preferably 0.1 mm to 0.8 mm.

With respect to the thermoplastic support layer, it is not necessary to have specially treated thermoplastic sheet, such as oriented to a certain retardation value, in order to incorporate it on a eyewear plastic article and to provide excellent optical quality, such as free of interference fringe colors when viewed with the protective layer facing the polarizing source. Although the support layer in this invention can be made from any optical grade thermoplastic sheet, it is desired, though, for the thermoplastic layer to be made from same or similar material as the optical article base so that the polarizing plate can be thermally integrated with the article base body through process such as injection molding. It is also desired that the thermoplastic layer resin has similar physical properties (e.g., glass transition temperature) to the selected resin for the protective layer in view of providing better forming compatibility. Preferred resins for the thermoplastic support layer include polycarbonate, polyimide, polyamide, polyurethane, polycyclicolefin or cyclic olefin copolymer. Considering most of molded polarized eyewear articles are based on polycarbonate, a thermoplastic support layer made from a polycarbonate sheet is more preferred.

The polycarbonate sheet for the support layer can be produced with any industry standard manufacturing method, such as hot-melt extruding, calendering, or casting. There is no specific requirement for the retardation value of the polycarbonate sheet used as the support layer. Extruded sheets are preferred from the economic viewpoint. Examples of optical grade polycarbonate include GE Lexan®, Bayer Makrolon®, and Teijin Panlite®. Theses extruded sheets (or films) usually have a retardation value between 100 nm and 1000 nm.

The thermoplastic support layer of the invention has a thickness comparable to the thermoplastic protective layer, of preferably 0.02 mm to 1.3 mm, and more preferably 0.1 mm to 0.8 mm.

An adhesive is used to adhere the thermoplastic protective layer and the thermoplastic support layer to the polarizing film. The adhesive used has to survive the high temperature in the injection molding or thermo-forming process. Strong enough adhesion should exist to prevent de-lamination during the process that the polarized optical article is made. Examples of adhesives include those based on isocyanate, polyhurethane, polythiourthane, epoxy, and acrylate. In order to have a still better adhesion between the thermoplastic sheet layer and the polarizing film, pre-treatment to the polarizing film surface and the thermoplastic sheet surface by methods commonly known to those skilled in the art is desired. Pre-treatment can be done by chemical corrosion such as treating with alkali solution or by plasma discharge such as corona.

Special additives such as colorant dyes and photochromic dyes can be included in the polarizing plate. They may exist in the protective layer or in the adhesive used bond the layer together. Optionally, an additional layer containing desired dyes may be included in the polarizing plate.

Polarized optical articles such as lenses with the polarizing plate of this invention can be made by methods such as injection molding, laminating, or casting. It is advantageous to use the polarizing plate of the invention to make polarized polycarbonate lenses with the insert injection molding method as disclosed in U.S. Pat. No. 6,328,446. In this method, the polycarbonate support layer will be partially fused into the base material to provide excellent adhesion.

### EXAMPLES

The polarizing laminate plates of the present invention and their use in injection molded polarized lenses will now be illustrated with reference to the following examples. In these examples, the following methods of measurement are used.

(a) The visible light transmission (VLT, %) is measured by using a Hunter Lab UltraScan spectrophotometer.

(b) The parallel position VLT (T₀,the VLT of a structure obtained by aligning the polarizing axis of sample polarizing plate parallel to the axis of a standard gray polarizer), the right angle position VLT (T₉₀, the VLT of a structure obtained by aligning the polarizing axis of sample polarizing plate perpendicular to the axis of a standard gray polarizer) are measured to determine the polarizing efficiency, P. It is defined as following:

$$P = \sqrt{\frac{{T}_{0} - {T}_{90}}{{T}_{0} + {T}_{90}}} \times 100$$

(c) The retardation value (R, nm) is defined by the following equation:
Retardation value (R)=Δn·d

Wherein Δn is the birefringence of the protective sheet, and d is the thickness (nm) of the sheet. The retardation value at 560 nm is measured under ambient condition with an automatic ellipsometry (VASE ellipsometer by J. A. Woollam Co.).

The colored interference fringe in a polarizing plate or a polarized lens molded with a polarizing plate is observed and evaluated by placing the sample, with the protective layer facing down, on top of an illuminated standard polarizer. Observation is done with naked eyes.

In the examples, a regular polycarbonate sheet was obtained from GE Polymershapes (Boston, Mass.). The thickness of the polycarbonate sheet is 15 mil and has variable retardation values from 15 nm to 350 nm across the area. A low birefringence (retardation less than 50 nm) optical quality film (OQF), 15 mil thick polycarbonate sheet was also obtain from GE Polymershapes.

### Example 1

A polarizing film based on polyvinyl alcohol—polyvinylene (or polyacetylene) block copolymer material was prepared according to Columns 7 to 8 of U.S. Pat. No. 5,666,223. In brief, a 3.15 mil thick PVA film (Kodacel from Eastman Kodak, Rochester, N.Y.) was unidirectionally stretched 3 times its orginal length at about 125° C. The stretched film was placed in a vessel containing concentrated HCl (37.6%) at about 40° C. for 2 minutes. The film was about 1.5 cm above the liquid. A dehydration process was followed by heating the film at about 125° C. for 2 minutes. The dehydrated film was then immersed in a D.I. water bath of about 50° C., and subsequently stretched about 60% more. The use of boric acid was omitted. Finally, the film was rinsed with water and dried at 110° C. for 5 minutes. The polarizing film so obtained has a single film VLT of 24.2%, and a polarizing efficiency of 98.3% over the visible light spectrum.

The above polarizing film was laminated between a sheet of poly(methyl methacrylate) (PMMA) as the protective layer and a regular sheet of polycarbonate as the support layer by using a polyurethane adhesive. The PMMA sheet (Autoflex from Autotype International, Wantage, England) is 10 mil thick and has a formable hard coating on the out side surface. The retardation value of the PMMA sheet is less than 100 nm.

A 6-diopter semi-finished single vision lens was made by molding polycarbonate onto the polycarbonate support layer of the above polarizing laminate plate with the insert injection molding process described in U.S. Pat. No. 6,328,446. No color change in the polarizing film and no significant reduction of polarization was observed. When the lens was placed on top of illuminated instrumental polarizing plate in any direction with the PMMA side facing the polarizing light, colored interference fringe patterns were not observed.

### Example 2

A polyvinyl alcohol—polyacetylene copolymer polarizing film, having a single film VLT of 17.0%, and a polarizing efficiency of 97.6% over the visible light spectrum, was prepared according to the procedure in Example 1. The polarizing film was laminated between an oriented polycarbonate sheet as the protective layer and a regular polycarbonate sheet as the support layer by using a polyurethane adhesive. The oriented polycarbonate sheet is 15 mil thick, and has a retardation value of about 4,000 nm.

Again, a 6-diopter semi-finished single vision lens was made by molding polycarbonate onto the polycarbonate support layer of the above polarizing plate. No color change in the polarizing film and no significant reduction of polarization was observed. When the lens was placed on top of illuminated instrumental polarizing plate in any direction with the oriented polycarbonate side facing the polarizing light, colored interference fringe patterns were not observed.

### Example 3

A polyvinyl alcohol—polyacetylene copolymer polarizing film, having a single film VLT of 39.7%, and a polarizing efficiency of 91.0% over the visible light spectrum, was prepared according to the procedure in Example 1. The polarizing film and a polycarbonate gray filter film (50% VLT, 3 mil thick) were laminated between an oriented polysulfone sheet as the protective layer and a regular polycarbonate sheet as the support layer by using a polyurethane adhesive. The oriented polysulfone sheet is 6 mil thick, and has a retardation value of about 3,000 nm. The polarizing plate so obtained has four layers, omitting the adhesive, in the following sequence: oriented polysulfone sheet, polarizing film, gray filter film, and polycarbonate sheet. The final VLT of the polarizing plate is 20.0%.

Again, a 6-diopter semi-finished single vision lens was made by molding polycarbonate onto the polycarbonate support layer of the above polarizing plate. No color change in the polarizing film and no significant reduction of polarization was observed. When the lens was placed on top of illuminated instrumental polarizing plate in any direction with the oriented polysulfone side facing the polarizing light, very slightly colored interference fringes were noted. This causes no problem in the practical use of the polarized lens as a sunscreen.

### Example 4

A gray TCF polarizing film on 20 mil thick polycarbonate sheet was supplied by Optiva (San Francisco, Calif.). It was laminated between a cellulose acetate butyrate (CAB) sheet as the protective layer and an optical quality polycarbonate sheet as the support layer. The CAB sheet, obtained from Eastman Kodak (Rochester, N.Y.) is 15 mil thick, and has a retardation value of about 4,000 nm. The so obtained polarizing laminate plate has a single film VLT of 31.6%, and a polarizing efficiency of 98.1% over the visible light spectrum.

Again, a 6-diopter semi-finished single vision lens was made by molding polycarbonate onto the polycarbonate support layer of the above polarizing plate. No color change in the polarizing film was observed. When the lens was placed on top of illuminated instrumental polarizing plate in any direction with the CAB side facing the polarizing light, colored interference fringe patterns were not observed.

### Comparison Example 1

The procedure of Example 4 was followed, except the polarizing film was replaced by a gray iodine—polyvinyl alcohol based polarizing film. The polarizing laminate had a VLT of 16.3% and a polarizing efficiency of higher than 99.0%. However, after molded into a polarized semi-finished single vision lens, significant color change and VLT reduction in the polarizing film was observed although significant deduction of polarizing efficiency was not observed. The molded lens had a VLT of 38.3%.

### Comparison Example 2

The procedure of Example 4 was followed, except the CAB protective layer was replaced by a 15 mil thick, OQF polycarbonate film (non-oriented). After the polarizing laminate plate was molded into a polarized semi-finished single vision lens, marked interference fringes was noted.

The foregoing detailed description of the preferred embodiments of the invention has been provided for the purposes of illustration and description. They are not intended to be exhaustive or to limit the invention to the precise embodiments disclosed. Many modifications and variations will be apparent to practitioners skilled in the art to which this invention pertains. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A polarizing plate comprising a light polarizing film bonded on one side with a thermoplastic support layer, and on another side with a thermoplastic protective layer; said light polarizing film being a material selected from the group consisting of polyacetylene, aromatic polyester homo-polymer with dichroic dye, aromatic polyester copolymer with dichroic dye, blend of aromatic polyester homo-polymer and aromatic polyester copolymer with dichroic dye, aromatic liquid crystal polymer incorporated with dichroic dyes, oriented dichroic dye crystalline,_and wherein said thermoplastic support layer and thermoplastic protective layer each have a thickness within a range from about 0.02 mm to about 1.3 mm.

2. The polarizing plate of claim 1 wherein the thermoplastic protective layer has a retardation value of higher than 2,000 nm.

3. The polarizing plate of claim 1 wherein the thermoplastic protective layer has a retardation value of less than 200 nm and a stress-optic coefficient of less than 30×10−6 mm2/N.

4. The polarizing plate of claim 1 wherein the thermoplastic support layer and the thermoplastic protective layer are made from the same type of resin material.

5. The polarizing plate of claim 2 wherein the thermoplastic protective layer comprises a thermoplastic sheet of resin material selected from the group consisting of a polycarbonate, a polysulfone, a polyarylate, a ester of (meth)acrylic acid, and an aromatic polyester.

6. The polarizing plate of claim 3 wherein the thermoplastic protective layer is constructed from a thermoplastic sheet of resin material selected from the group consisting of a cellulose ester, a ester of (meth)acrylic acid, a copolymer of cyclic olefin, and a polystyrene.

7. The polarizing plate of claim 1, wherein said support layer is a polycarbonate sheet; and wherein said protective layer is a sheet of oriented resin material selected from the group consisting of a polycarbonate, a polysulfone, an ester of (meth)acrylic acid, and an aromatic polyester.

8. The polarizing plate of claim 1, wherein said support layer is colored for the purpose of modifying color and reducing light transmission of said polarizing plate.

9. A polarized optical eyewear article made by injection molding polycarbonate material onto the polycarbonate support layer of the light polarizing plate as set forth in claim 1.

10. A laminate polarizing film comprising:
a thermoplastic protective layer;
a light polarizing layer;
a thermoplastic support layer;
wherein said light polarizing layer comprises a material selected from the group consisting of polyacetylene, aromatic polyester homo-polymer with dichroic dye, aromatic polyester copolymer with dichroic dye, blend of aromatic polyester homo-polymer and aromatic polyester copolymer with dichroic dye, aromatic liquid crystal polymer incorporated with dichroic dyes, oriented dichroic dye crystalline and,
wherein said thermoplastic protective layer comprises a birefringent thermoplastic protective layer.

11. The polarizing plate of claim 10 wherein the thermoplastic protective layer has a retardation value of higher than 2,000 nm.

12. The polarizing plate of claim 10 wherein the thermoplastic protective layer has a retardation value of less than 200 nm and a stress-optic coefficient of less than 30×10−6 mm2/N.

13. The polarizing plate of claim 10 wherein the thermoplastic support layer and the thermoplastic protective layer are made from the same type of resin material.

14. The polarizing plate of claim 11 wherein the thermoplastic protective layer comprises a thermoplastic sheet of resin material selected from the group consisting of a polycarbonate, a polysulfone, a polyarylate, a ester of (meth)acrylic acid, and an aromatic polyester.

15. The polarizing plate of claim 12 wherein the thermoplastic protective layer is constructed from a thermoplastic sheet of resin material selected from the group consisting of a cellulose ester, a ester of (meth)acrylic acid, a copolymer of cyclic olefin, and a polystyrene.

16. The polarizing plate of claim 10, wherein said thermoplastic support layer is a polycarbonate sheet; and wherein said thermoplastic protective layer is a sheet of oriented resin material selected from the group consisting of a polycarbonate, a polysulfone, an ester of (meth)acrylic acid, and an aromatic polyester.

17. The polarizing plate of claim 10, wherein said thermoplastic support layer is colored for the purpose of modifying color and reducing light transmission of said polarizing plate.
